(19) United States
(12) Patent Application Publication
(10) Pub. No.: US 2001/0040774 A1
(43) Pub. Date: Nov. 15, 2001

(54) METHOD AND SYSTEM FOR IMPROVING THE SENSITIVITY OF A SPIN VALVE MAGNETORESISTANCE SENSOR

(75) Inventors: SHIN FUNADA, PLEASANTON, CA (US); MING MAO, PLEASANTON, CA (US); HUA-CHING TONG, SAN JOSE, CA (US)

Correspondence Address: JOSEPH A SAWYER JR, SAWYER & ASSOCIATES, PO BOX 51418, PALO ALTO, CA, 94303

(73) Assignee: Read-Rite Corporation

(21) Appl. No.: 09/376,679

(22) Filed: Aug. 18, 1999

(51) Int. Cl. G11B 5/39

(52) U.S. Cl. 360/314

(57) ABSTRACT

A method and system for providing a dual spin valve is disclosed. The dual spin valve is for reading data in a magnetic recording media. The method and system include providing a first pinned layer. The first pinned layer has a first magnetization. The method and system also include providing a CoFe free layer and providing a first nonmagnetic spacer layer. The first nonmagnetic spacer layer is between the first pinned layer and the CoFe free layer. The method and system also include providing a second pinned layer and a second nonmagnetic spacer layer. The second pinned layer has a second magnetization. The second nonmagnetic spacer layer is between the CoFe free layer and the second pinned layer.

### FIELD OF THE INVENTION

The present invention relates to magnetic recording technology, and more particularly to a method and system for providing a spin valve read sensor having greater sensitivity to data stored on a magnetic recording media.

### BACKGROUND OF THE INVENTION

FIG. 1 is a block diagram of a conventional magnetoresistance (“MR”) head 10 which uses a MR sensor 30. The conventional MR head 10 may be part of a read head or in a composite head, which includes a read head and a write head. The conventional MR head 10 includes a first shield 14 formed on a substrate 12. The conventional MR head 10 also includes a first gap 16 separating a conventional MR sensor 30 from the first shield 14. The conventional MR head 10 also includes a pair of bias layers 18a and 18b. The bias layers 18a and 18b magnetically bias layers in the conventional MR sensor 30. The conventional MR head 10 also includes lead layers 19a and 19b, which conduct current to and from the conventional MR sensor 30. A second gap 20 separates the conventional MR sensor 30 from a second shield 22. When brought in proximity to a recording media (not shown), the conventional MR head 10 reads data based on a change in the resistance of the MR sensor 30 due to the field of the recording media.

FIG. 2 depicts a conventional dual spin valve 30′. The conventional dual spin valve 30′ may be used as the MR sensor 30 in the conventional MR head 10. The conventional dual spin valve 30′ senses magnetically stored data using giant magnetoresistance (“GMR”). GMR has been found to provide a higher signal for a given magnetic field and is believed to be based on spin dependent scattering at magnetic interfaces. The conventional dual spin valve 30′ typically includes a seed layer 32, a first antiferromagnetic (“AFM”) layer 34, a first pinned layer 36, a first spacer layer 38, a conventional free layer 40, a second spacer layer 42, a second pinned layer 44, a second AFM layer 46, and a capping layer 48. The seed layer 32 is used to ensure that the first AFM layer 34 has the desired properties. The AFM layers 34 and 46 are used to pin the magnetization of the first pinned layer 36 and the second pinned layer 44, respectively, in a particular direction. The first and second spacer layers 38 and 42, respectively, are made of nonmagnetic metal, such as copper. The first pinned layer 36, the conventional free layer 40, and the second pinned layer 44 are magnetic layers. The magnetization of the first pinned layer 36 is pinned in place due to an exchange coupling between the first AFM layer 34 and the first pinned layer 36. Similarly, the magnetization of the second pinned layer 44 is pinned in place due to an exchange coupling between the second AFM layer 46 and the second pinned layers 44.

The conventional free layer 40 is typically a multilayer. Thus, CoFe layer 41, NiFe layer 43, and CoFe layer 45 make up the conventional free layer 40. In an alternate embodiment, the conventional free layer 40 is made up of a single layer of NiFe. The CoFe layers 41 and 45 are typically about ten Angstroms thick. The CoFe layers 41 and 45 serve as barrier layers to help prevent interdiffusion between the between the NiFe layer 43 and the spacer layers 38 and 42, which are typically made of Cu. The NiFe layer 43 is typically between ten and fifty Angstroms and accounts for the magnetic properties of the free layer 40. Thus, the NiFe layer 43 accounts for the magnetoresistance of the conventional dual spin valve 30′.

The magnetization of the conventional free layer 40 is free to rotate. Based on the rotation of the magnetization of the conventional free layer 40 with respect to the magnetizations of the pinned layers 36 and 44, the resistance of the conventional dual spin valve 30′ changes. The change in resistance of the conventional dual spin valve 30′ due to an applied magentic field, or the MR of the conventional dual spin valve 30′, provide a signal used to read data stored on a magnetic recording media.

Although the conventional dual spin valve 30′ functions, one of ordinary skill in the art will realize that the signal generated by the conventional dual spin valve is desired to be larger. The current trend in magnetic recording technology is toward higher density and, therefore, smaller bit size. As magnetic recording technology utilizes smaller bit sizes, the magnetic field generated by each bit is reduced. Consequently, the rotation of the magnetization of the conventional free layer 40 is smaller for higher density recording media. The change in resistance of the conventional dual spin valve 30′ and, therefore, the signal generated by the conventional dual spin valve 30′ in response to higher density recording media is smaller. Thus, the signal generated for a given magnetic field is desired to be larger. However, the signal produced by the conventional spin valve 30′ having the conventional free layer 40 is limited. Thus, it would be desirable for the conventional dual spin valve 30′ to have a higher change in resistance versus magnetic field.

Accordingly, what is needed is a system and method for providing a magnetic read sensor having improved sensitivity. It would also desirable for some other properties of the magnetic read sensor to remain unaffected or be improved. For example, it is desirable for the free layer to have a low coercivity (H_{cf}). It is also desirable to have a large exchange field between the pinned layers and the AFM or other layers which pin the magnetization of the pinned layers. The large exchange field improves the stability of the pinned layers and, therefore, the read sensor. Furthermore, it is desirable to have a low interlayer coupling between the free layer and the pinned layers to allow the free layer to rotate freely in response to the magnetic field of the recording media. It is also desirable to have low interface diffusion, for example between the free layer and the spacer layers, to prevent mixing of layers. The present invention addresses such a need.

Why is a Low Free Layer Coercivity Desirable?

### SUMMARY OF THE INVENTION

The present invention provides a method and system for providing a dual spin valve. The dual spin valve is for reading data in a magnetic recording media. The method and system comprise providing a first pinned layer. The first pinned layer has a first magnetization. The method and system also comprise providing a CoFe free layer and providing a first nonmagnetic spacer layer. The first nonmagnetic spacer layer is between the first pinned layer and the CoFe free layer. The method and system also comprise providing a second pinned layer and a second nonmagnetic spacer layer. The second pinned layer has a second magnetization. The second nonmagnetic spacer layer is between the CoFe free layer and the second pinned layer.

According to the system and method disclosed herein, the present invention provides a dual spin valve having higher sensitivity. Furthermore, other properties of the dual spin valve may remain unchanged or be improved. For example, the coercivity of the CoFe free layer, interlayer coupling field, and interdiffusion may remain low. In addition the exchange field may remain large.

### BRIEF DESCRIPTION OF THE DRAWINGS

FIG. 1 is a diagram of a conventional magnetoresistance read head.

FIG. 2 is a diagram of a conventional spin valve.

FIG. 3 is a diagram of a spin valve in accordance with the present invention.

FIG. 4 is a flow chart depicting one embodiment of a method for providing a spin valve in accordance with the present invention.

FIG. 5 is graph depicting the change in resistance versus NiFe thickness.

FIG. 6 is a graph depicting the temperature dependence of the giant magnetoresistance for a conventional spin valve and a spin valve in accordance with the present invention.

FIG. 7 is a graph depicting the coercivity and interlayer coupling field versus NiFe thickness.

FIG. 8 is a graph depicting the dependence of the change in resistance for three embodiments of a spin valve in accordance with the present invention.

FIG. 9 is a graph depicting the dependence of the giant magnetoresistance, interaction field, and coercivity for three embodiments of a spin valve in accordance with the present invention.

### DETAILED DESCRIPTION OF THE INVENTION

The present invention relates to an improvement in magnetic recording technology. The following description is presented to enable one of ordinary skill in the art to make and use the invention and is provided in the context of a patent application and its requirements. Various modifications to the preferred embodiment will be readily apparent to those skilled in the art and the generic principles herein may be applied to other embodiments. Thus, the present invention is not intended to be limited to the embodiment shown, but is to be accorded the widest scope consistent with the principles and features described herein.

Conventional dual spin valves are used for the magnetoresistance (“MR”) read sensor in conventional MR heads. The dual spin valve typically includes a conventional free layer, which has a magnetization that rotates in response to a magnetic field from a recording media. The conventional dual spin valve has a resistance that depends upon difference between the direction of the magnetization of the conventional free layer and pinned layers. Thus, based upon the rotation of the magnetization of the conventional free layer, the conventional dual spin valve can read data stored on the conventional recording media.

The conventional free layer is typically a multilayer that uses a NiFe layer in order to sense the magnetization of the recording media. Typically, the NiFe layer is sandwiched between two CoFe barrier layers. The CoFe barrier layers help to prevent interdiffusion between the NiFe layer and Cu spacer layers which are on either side of the conventional free layer.

Although the conventional dual spin valve functions, higher sensitivity is desired. It is desirable for read heads to be capable of reading higher density recording media having a smaller bit size. Smaller bits generate smaller magnetic fields. The rotation of the conventional free layer in response to the smaller magnetic field results in a smaller change in resistance of the conventional dual spin valve. Consequently, the conventional dual spin valve generates a smaller signal. A free layer and, therefore, a dual spin valve that is more sensitive is desired. Furthermore, it would be desirable to improve other properties of the dual spin valve or keep other properties of the conventional dual spin valve substantially unchanged.

The present invention provides a method and system for providing a dual spin valve. The dual spin valve is for reading data in a magnetic recording media. The method and system comprise providing a first pinned layer. The first pinned layer has a first magnetization. The method and system also comprise providing a CoFe free layer and providing a first nonmagnetic spacer layer. The first nonmagnetic spacer layer is between the first pinned layer and the CoFe free layer. The method and system also comprise providing a second pinned layer and a second nonmagnetic spacer layer. The second pinned layer has a second magnetization. The second nonmagnetic spacer layer is between the CoFe free layer and the second pinned layer.

The present invention will be described in terms of dual spin valve having particular components. However, one of ordinary skill in the art will readily recognize that this method and system will operate effectively for other components having similar properties. For example, the present invention will be discussed in terms of a dual spin valve using AFM pinning layers and pinned layers including specific materials. However, one of ordinary skill in the art will readily realize that other materials, such as synthetic AFM pinning layers, no pinning layers, synthetic pinned layers, or pinned layers including other materials could be utilized.

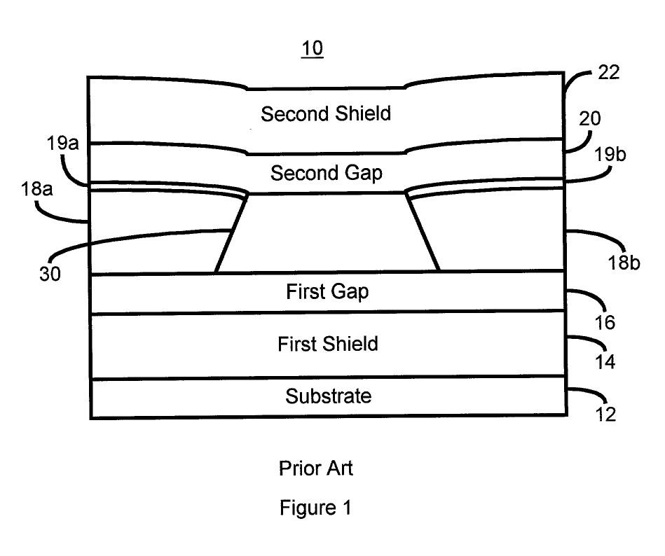

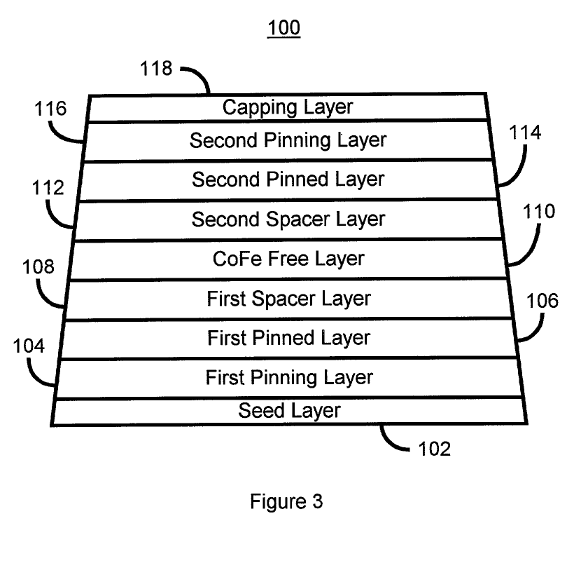

To more particularly illustrate the method and system in accordance with the present invention, refer now to FIG. 3, depicting one embodiment of a dual spin valve 100 in accordance with the present invention. The dual spin valve 100 could be used in the conventional MR head 10, depicted in FIG. 1, as the MR sensor 30. Referring back to FIG. 3, the dual spin valve 100 includes an optional seed layer 102, a first pinning layer 104, a first pinned layer 106, a first spacer layer 108, a CoFe free layer 110, a second spacer layer 112, a second pinned layer 114, a second pinning layer 116, and an optional capping layer 118. The CoFe free layer 110, the first pinned layer 106, and the second pinned layer 114 are magnetic. The first pinning layer 104 and second pinning layer 116 are used to pin the directions of magnetization of the first pinned layer 106 and the second pinned layer 114, respectively. In one embodiment, the pinning layers 104 and 116 are antiferromagnetic (AFM). In another embodiment, the pinning layers 104 and 116 are synthetic AFM layers.

The pinned layers 106 and 114 are magnetic. In a preferred embodiment, the pinned layers 106 and 114 are made of CoFe and are approximately twenty Angstroms thick. However, nothing prevents the use of another magnetic material or another thickness for the pinned layers 106 and 114. The spacer layers 108 and 112 are nonmagnetic. In a preferred embodiment, the spacer layers 108 and 112 are Cu and are approximately twenty to twenty-five Angstroms thick.

The CoFe free layer 110 is preferably a single layer consisting of CoFe. The CoFe free layer 110 can be a range of thicknesses, for example between approximately ten and approximately twenty Angstroms. In a preferred embodiment, the CoFe free layer 110 is approximately fifteen Angstroms thick.

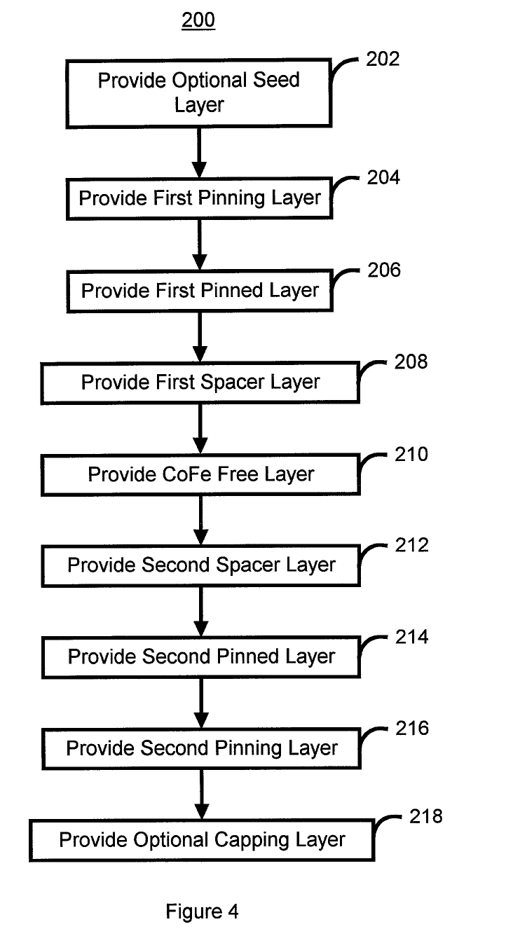

FIG. 4 depicts one embodiment of a method 200 for providing the CoFe free layer. The optional seed layer 102 may be provided, via step 202. The first pinning layer 104 is then provided, via step 204. The first pinned layer 106 is provided on the first pinning layer 104a step 206. The first spacer layer 108 is then provided on the first pinned layer 106, via step 208. The CoFe free layer 110 is then provided, via step 210. The second spacer layer 112 and second pinned layer 114 are then provided, via steps 212 and 214, respectively. The second pinning layer 116 is then provided, via step 216. The optional capping layer may then be provided, via step 218.

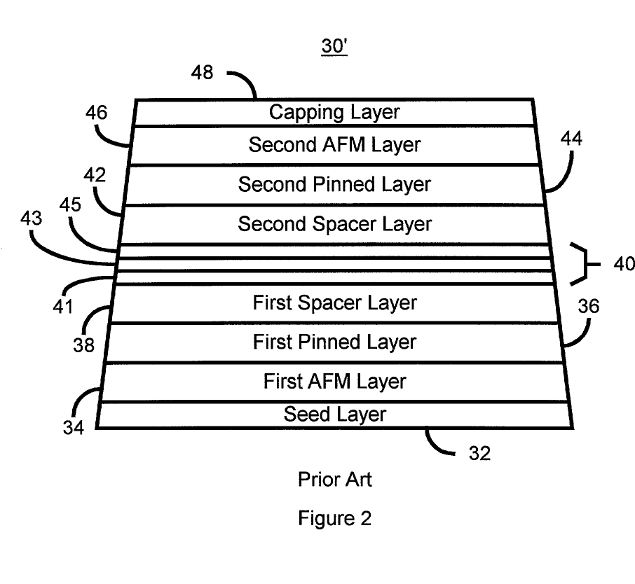

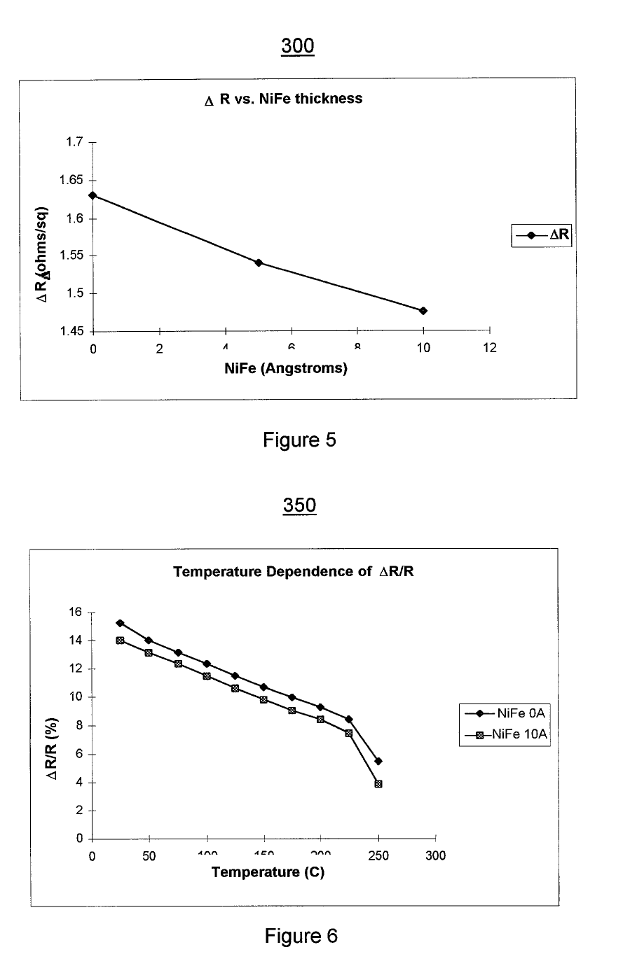

The dual spin valve 100 having the CoFe free layer 110 has higher sensitivity than the conventional dual spin valve 30′ depicted in FIG. 2. FIG. 5 is a graph 300 of the change in resistance, ΔR, for magnetic field versus the thickness of NiFe in the free layer. A NiFe layer thickness of zero Angstroms corresponds to a dual spin valve 100 in accordance with the present invention. An NiFe layer thickness of greater than zero Angstroms corresponds to a NiFe layer 43 in the conventional free layer 40 of the conventional dual spin valve 30′, depicted in FIG. 2. Referring back to FIG. 5, a free layer, such as the free layer 110, having no NiFe has the highest change in resistance.

FIG. 6 is a graph 350 depicting the MR, ΔR/R, versus temperature for two dual spin valves. One dual spin valve for which data is shown is one embodiment of a dual spin valve 100 in accordance with the present invention, having a NiFe thickness of zero Angstroms. The other dual spin valve is a conventional dual spin valve 30′, which includes a NiFe layer 43 having a thickness of ten Angstroms. As can be seen in FIG. 6, the dual spin valve 100 having a NiFe thickness of zero has a higher MR than the conventional dual spin valve 30′ at all temperatures between approximately room temperature and two hundred and fifty degrees Celsius. Thus, the dual spin valve 100 in accordance with the present invention has a higher MR than the conventional dual spin valve 30′ over the operating range. Because the dual spin valve 100 has a higher MR and a higher ΔR, the dual spin valve 100 in accordance with the present invention has a higher sensitivity than the conventional dual spin valve 30′. Consequently, the dual spin valve 100 may be used to reading higher density recording media.

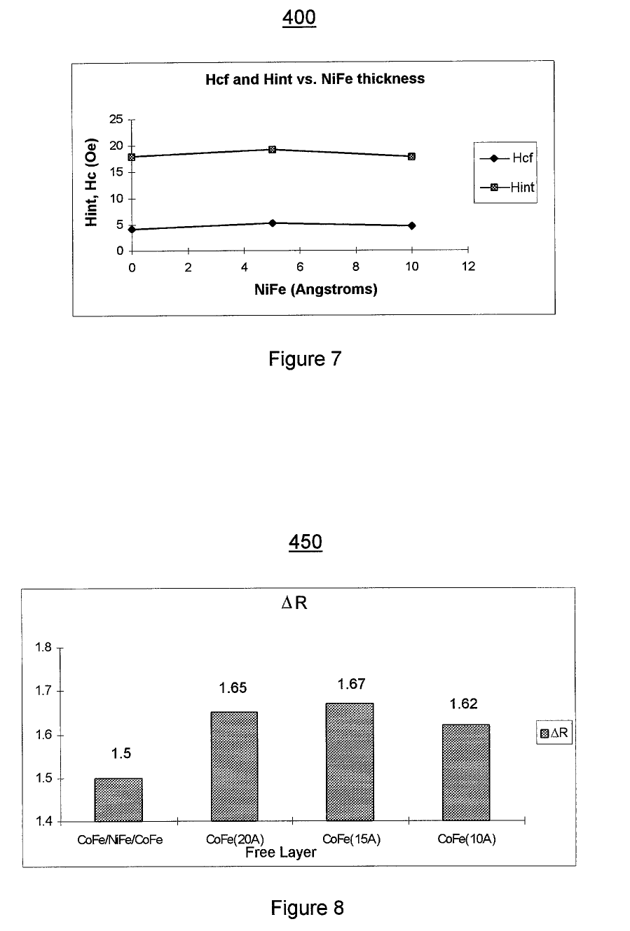

FIG. 7 is a graph 400 depicting the free layer coercivity, Hcf, and interaction field, Hint, versus NiFe layer thickness. Thus, the graph 400 compares other properties of the dual spin valve 100 in accordance with the present invention to a conventional dual spin valve 30′. As can be seen in FIG. 7, the free layer coercivity and interaction field do not vary greatly with the NiFe layer thickness. A dual spin valve 100 in accordance with the present invention, having a NiFe layer thickness of zero Angstroms, has a free layer coercivity and interaction field similar to that of a conventional dual spin valve, which has a nonzero NiFe layer thickness. Consequently, the dual spin valve 100 in accordance with the present invention has increased sensitivity without sacrificing performance of other properties such as the free layer coercivity and interaction field.

FIG. 8 depicts the change in resistance, ΔR, for a conventional dual spin valve 30′ and for three embodiments of the dual spin valve 100 in accordance with the present invention. The conventional dual spin valve 30′ is labeled as having a CoFe/NiFe/CoFe free layer. The embodiments of the dual spin valve 100 in accordance with the present invention are labeled as having CoFe free layers 110 of twenty, fifteen, and ten Angstroms in thickness. The embodiments of the dual spin valve 100 also have CoFe pinned layers 106 and 114. As can be seen in FIG. 8, all embodiments of the dual spin valve 100 have a higher change in resistance than the conventional spin valve 30′. Furthermore, the embodiment of the dual spin valve 100 having a CoFe free layer 110 that is fifteen Angstroms thick has the largest change in resistance. Thus, the embodiment of the dual spin valve 100 having a CoFe free layer thickness of fifteen Angstroms is a preferred dual spin valve 100.

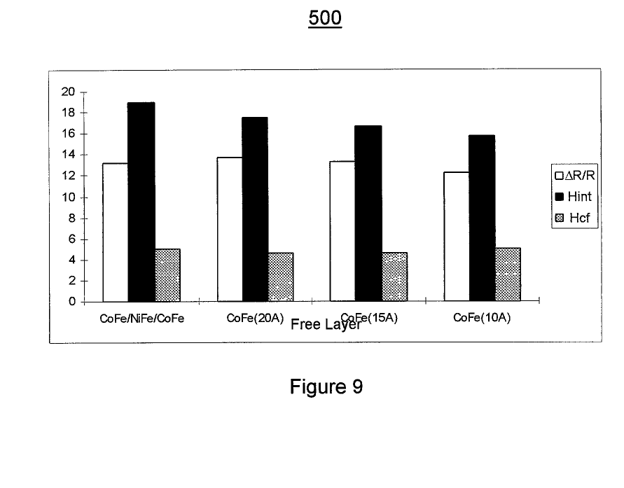

FIG. 9 is a graph 500 depicting the MR (ΔR/R), the interaction field (Hint), and the free layer coercivity (Hcf), for a conventional dual spin valve 30′ and three embodiments of the dual spin valve 100 in accordance with the present invention. Data for the conventional dual spin valve 30′ is labeled as having a CoFe/NiFe/CoFe free layer. The embodiments of the dual spin valve 100 in accordance with the present invention are labeled as having CoFe free layers 110 of twenty, fifteen, and ten Angstroms in thickness. The embodiments of the dual spin valve 100 also have CoFe pinned layers 106 and 114. As can be seen in FIG. 8, the MR of embodiments of the dual spin valve 100 have a higher MR than the conventional dual spin valve 30′. Thus, the embodiments of the dual spin valve 100 all have higher sensitivity than the conventional dual spin valve. Furthermore, the free layer coercivity and the interaction field for all embodiments of the dual spin valve 100 do not vary greatly from the free layer coercivity and interaction field for the conventional spin valve 30′. Thus, the dual spin valve 100 has a higher sensitivity than the conventional spin valve 30′ without substantially changing other magnetic properties of the dual spin valve.

A method and system has been disclosed for providing a dual spin valve having a higher sensitivity. Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A dual spin valve for reading data in a magnetic recording media, the dual spin valve comprising:
a first pinned layer, the first pinned layer having a first magnetization;
a CoFe free layer;
a first nonmagnetic spacer layer between the first pinned layer and the CoFe free layer;
a second pinned layer having a second magnetization;
a second nonmagnetic spacer layer between the CoFe free layer and the second pinned layer.

2. The dual spin valve of claim 1 further comprising:
a first pinning layer magnetically coupled with the first pinned layer, the first pinning layer for pinning the first magnetization in a first direction.

3. The dual spin valve of claim 2 further comprising:
a second pinning layer magnetically coupled with the second pinned layer, the second pinning layer for pinning the second magnetization in a second direction.

4. The dual spin valve of claim 3 wherein the first direction and the second direction are substantially the same.

5. The dual spin valve of claim 2 wherein the first pinning layer further includes a first antiferromagnetic pinning layer.

6. The dual spin valve of claim 3 wherein the first pinning layer further includes a first antiferromagnetic pinning layer and wherein the second pinning layer further includes a second antiferromagnetic pinning layer.

7. The dual spin valve of claim 2 wherein the first pinning layer further includes a first synthetic antiferromagnetic pinning layer.

8. The dual spin valve of claim 3 wherein the first pinning layer further includes a first synthetic antiferromagnetic pinning layer and wherein the second pinning layer further includes a second synthetic antiferromagnetic pinning layer.

9. The dual spin valve of claim 1 wherein the CoFe free layer has a thickness of approximately fifteen Angstroms.

10. The dual spin valve of claim 1 wherein the first nonmagnetic spacer layer includes a first copper layer and the second nonmagnetic spacer layer includes a second copper layer.

11. A method for providing dual spin valve comprising the steps of:
(a) providing a first pinned layer having a first magnetization;
(b) providing a first nonmagnetic spacer layer above the first pinned layer;
(c) providing a CoFe free layer above the first pinned layer;
(d) providing a second nonmagnetic spacer layer above the CoFe free layer;
(e) providing a second pinned layer having a second magnetization.

12. The method of claim 11 further comprising the step of:
(f) providing a first pinning layer magnetically coupled with the first pinned layer, the first pinning layer for pinning the first magnetization in a first direction.

13. The method of claim 12 further comprising the step of:
(g) providing a second pinning layer magnetically coupled with the second pinned layer, the second pinning layer for pinning the second magnetization in a second direction.

14. The method of claim 13 wherein the first direction and the second direction are substantially the same.

15. The method of claim 12 wherein the first pinning layer further includes a first antiferromagnetic pinning layer.

16. The method 13 wherein the first pinning layer further includes a first antiferromagnetic pinning layer and wherein the second pinning layer further includes a second antiferromagnetic pinning layer.

17. The method of claim 12 wherein the first pinning layer further includes a first synthetic antiferromagnetic pinning layer.

18. The method 13 wherein the first pinning layer further includes a first synthetic antiferromagnetic pinning layer and wherein the second pinning layer further includes a second synthetic antiferromagnetic pinning layer.

19. The method of claim 11 wherein the CoFe free layer has a thickness of approximately fifteen Angstroms.

20. The method of claim 11 wherein the first nonmagnetic spacer layer includes a first copper layer and the second nonmagnetic spacer layer includes a second copper layer.
